(19) United States
(12) Patent Application Publication
(10) Pub. No.: US 2010/0196723 A1
(43) Pub. Date: Aug. 5, 2010

(54) Surface Applied Waterproofing Compositions And Methods For Concrete Systems

(75) Inventors: Shayne Veramallay, Hillsborough, NJ (US); David C. Darwin, Wayne, NJ (US)

Correspondence Address: MCCARTER & ENGLISH, LLP STAMFORD, CANTERBURY GREEN, 201 BROAD STREET, 9TH FLOOR, STAMFORD, CT, 06901, US

(73) Assignee: HYCRETE, INC., Carlstadt, NJ (US)

(21) Appl. No.: 12/365,331

(22) Filed: Feb. 4, 2009

(51) Int. Cl. C08K 5/098; B32B 27/06

(52) U.S. Cl. 428/447; 524/397

(57) ABSTRACT

Water soluble compositions for use in sealing and/or waterproofing concrete-containing materials and surfaces are disclosed. The compositions include carboxylic acid and polysiloxane constituents. Despite the water soluble properties of the composition, the treatments are effective in delivering an advantageous level of moisture resistance to the treated concrete-containing structure and/or surface. Synergistic properties of the composition deliver reductions in polysiloxane levels without diminution in sealing and/or waterproofing effectiveness.

### BACKGROUND

1. Technical Field

The present disclosure is directed to advantageous compositions and methods for sealing and/or waterproofing treatment of concrete systems/surfaces. More particularly, the present disclosure is directed to sealing/waterproofing compositions that include, in combination, a dicarboxylic acid and a polysiloxane to achieve beneficial sealing/waterproofing results for concrete systems/surfaces.

2. Background Art

Concrete durability is often a function of deleterious species which enter and reside in the pore space of the hardened concrete. Because conventional concrete has very low tensile strength, it is common practice to reinforce concrete with steel bars in applications where the concrete is subjected to substantial loads. In such implementations, the concrete has at least two functions. One function is to protect the reinforcing steel bars against corrosion. Another prominent function is to improve resistance from shear and compressive stresses. As a general matter, the protective effect of hardened concrete against climatic and environmental conditions on reinforcing steel depends, for example, on the amount and type of cement, water/cement factor and concrete integrity.

However, since concrete is also a permeable absorptive material, concrete is often subject to undesirable intrusion of moisture and other substances, each of which can lead to corrosion of the reinforcing steel and other deleterious effects. Some of the species which permeate into the concrete pores can include water, chlorides, sulfates and acids. Common mechanisms by which species enter into concrete and concrete-containing systems include diffusion and sorption of water and/or moisture. As reinforcing steel (if present) corrodes, it expands, thus cracking the concrete, which in turn allows for more impurity invasion, e.g., water ingress, which in turn advances corrosion as the cycle builds. Moreover, as a result of various distresses, such as environmental conditions, including at least shear and compressive stresses, accumulated after some length of service, the concrete can eventually crack and fail. These processes often lead to premature deterioration and subsequent failure of concrete structures.

The cost of corrosion in materials is significant with respect to damage and deterioration to structures as well as the potential for human injury. From a financial perspective, the cost of corrosion is estimated to be over $300 billion each year in the United States.

Reducing the permeability of concrete is a fundamental strategy for keeping potentially deleterious species out of concrete pores. Waterproofing treatments may be employed to alter the pores, e.g., at the time of mix design and/or with fresh, plastic concrete. Techniques used to alter cement pores so as to reduce permeability include using additional cementitious materials to reduce the number of pores, employing “densifiers” (which are normally minerals or siliceous by-products) that serve to partially block the pores, and/or applying integral waterproofing admixtures which block the pores by various mechanisms.

If permeation reduction is not affected at the time of mix design, unprotected concretes can have their permeation reduced through various coating technologies. Two types of coatings are common: (i) surface barrier coatings and (ii) penetrating scalers. Surface barrier coatings can be highly effective, but they alter the surface of the concrete in ways that may be undesirable, including potential color changes, surface texture alteration, especially reduced friction or slipperiness, and potential for adhesive failures. Penetrating scalers wick into the pores to a small depth and can leave the concrete surface properties unchanged.

Penetrating concrete waterproofing sealers are commercially available. Common technologies used in the industry are silanes, polysiloxanes, organics and silicates. The silane, polysiloxane and organic sealants can be supplied either as solvent-based or water-based formulations. Water-based formulations have come to a preferred position in the marketplace due to their environmentally preferred reduction of “Volatile Organic Compounds” (VOCs). Among water-based penetrating sealers for concrete, polysiloxanes are one of the most common variants.

Further teachings in the patent literature include U.S. Pat. No. 4,869,752 to Jaklin, which describes the use of modified inorganic silicates, e.g., modified alkali silicates, as a concrete additive to prevent corrosion of steel structures or reinforcing steel. U.S. Pat. No. 6,277,450 to Katoot describes the use of a coating process to coat metal surfaces which are modified to an active moiety of metal hydroxide receptive to a filly cross-linked polymer of various thicknesses. Other processes that have been used have included precoating surfaces of metals used in the building and construction industry. However, such methods are generally costly, ineffective and inefficient/impractical. Additional teachings in the patent literature related to treatment techniques and/or materials include U.S. Pat. Nos. 6,174,461, 5,811,483; 5,702,509; 5,449,712; 5,051,129; and 4,876,152.

In commonly assigned applications and patents, materials and systems for treatment of concrete structures have been disclosed. U.S. Patent Publication No. 2004/0237834 to Humphrey et al. discloses a composition for concrete treatment and a method for synthesis thereof. The disclosed composition is an alkali-based salt solution of a dioic acid of the following chemical formula:

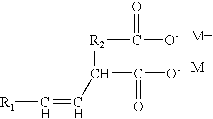

wherein M+ is selected from the group comprising Na+ and K+; R₁ is a C1 to C24 branch or linear aliphatic compound; and R₂ is a C1 to C10 branch or linear aliphatic compound.

Commonly assigned U.S. Pat. No. 7,381,252 to Rhodes et al. discloses a further concrete treatment system that includes the alkali-based salt solution of a dioic acid of the Humphrey et al. patent publication (U.S. Patent Publication No. 2004/0237834) in combination with a defoaming agent, e.g., a polyether modified polysilicane, tri-alkane/alkene phosphates and mixtures thereof. The disclosed defoaming agent is effective in reducing excessive air entrainment and/or foaming during preparation of concrete mixes and in controlling air content of the cured concrete. Commonly assigned U.S. Pat. No. 7,261,923 to Rhodes et al. teaches the application of an alkali-based salt solution of a dioic acid material to a hardened concrete surface and reports efficacious results. A further commonly assigned U.S. patent—namely, U.S. Pat. No. 7,407,535—describes, inter alia, anti-corrosion and moisture resistant compositions and treatment modalities. Each of the following commonly assigned patents and publications is incorporated by reference: U.S. Patent Publication No. 2004/0237834; U.S. Pat. No. 7,261,923; U.S. Pat. No. 7,381,252 and U.S. Pat. No. 7,407,535.

Reference is also made to a pair of publications by Mark Allyn, Jr. and Gregory C. Frantz. In a first publication, Allyn, Jr., et al. describe strength and durability testing of concrete containing salts of alkenyl-succinic acid, specifically disodium tetrapropenyl succinate (DSS) and diammonium tetrapropenyl succinate (DAS). [Allyn, Jr., et al., “Strength and Durability of Concrete Containing Salts of Alkenyl-Succinic Acid,” ACI Materials Journal, January-February 2001, pages 52-58]. In a second publication, Allyn, Jr., et al. describe corrosion testing of the foregoing materials over a 48 week period. [Allyn, Jr., et al., “Corrosion Tests with Concrete Containing Salts of Alkenyl-Substituted Succinic Acid,” ACI Materials Journal, May-June 2001, pages 224-232.]

Tests have shown that certain polysiloxanes exhibit higher water repellency as compared to the commonly assigned treatment systems referenced above, albeit at a higher surface coverage levels. Also, tests have shown that certain polysiloxanes exhibit a greater tendency to bead water on a concrete surface as compared to the commonly assigned treatment systems referenced above, thereby giving the visual appearance of higher water repellency.

Despite efforts to date, a need remains for alternative and improved treatment systems for improving the durability and performance of concrete systems. These and other needs are satisfied by the disclosed compositions and methods.

### SUMMARY

According to the present disclosure, advantageous water soluble materials, compositions and systems for use in treating concrete-containing structures, materials and surfaces are provided. The disclosed water soluble materials, compositions and systems are particularly useful in treatment modalities wherein hardened concrete-containing structures, materials and/or surfaces are subjected to one or more applications of the disclosed water soluble sealing/waterproofing composition, material or system. The disclosed treatment modalities are effective, inter alia, in reducing moisture/water absorption by treated concrete-containing structures, materials and/or surfaces.

The disclosed water soluble material, composition or system may be applied to a hardened concrete-containing structure or surface through various treatment techniques, e.g., by spraying, brushing or misting an effective amount of the disclosed material, composition or system onto one or more surfaces of the concrete-containing structure/surface. The treated structure(s) advantageously demonstrate reduced water/moisture permeation therein.

According to the present disclosure, an aqueous solution of a blend or mixture of molecules/compounds is utilized to achieve desired sealing/waterproofing properties. The disclosed water soluble blend/mixture includes (i) a dicarboxylic acid composition, and (ii) a polysiloxane composition. The dicarboxylic acid composition and polysiloxane composition may be combined at various levels to achieve desirable results, as described in greater detail below.

The disclosed dicarboxylic acid composition generally includes hydrocarbon molecules featuring branched side chains of varying carbon lengths. However, in preferred embodiments of the disclosed dicarboxylic acid composition, all or substantially all of the branched side chains include a specified number of carbon atoms, namely between nine (9) and sixteen (16) carbon atoms. Indeed, as described in commonly assigned U.S. Pat. No. 7,407,535, it has been found that branched side chains falling within a range of C9 to C16 (inclusive) are critical to the effectiveness of the disclosed material, composition or system when employed in the absence of a polysiloxane. In such applications, the inclusion of shorter branched hydrocarbon side chains (e.g., C8 and less) is ineffective because, when incorporated into a concrete-containing structure (whether at the mixing/formulation stage or at the post-construction stage), such smaller hydrocarbon side chains are highly likely to be washed away by permeating water, thereby failing to perform the advantageous anti-corrosion and moisture resistance functions of the disclosed treatment. In addition, in such applications, longer branched hydrocarbon side chains (e.g., C17 and higher) have been found to raise substantial water solubility issues.

The disclosed water soluble material, composition or system includes dicarboxylic acid molecules of the following formula:

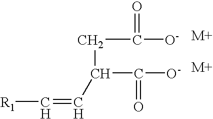

wherein R₁ is a branched hydrocarbon and M+ is Na+, K+ or other monovalent cation constituent. Of note, the disclosed water soluble material constitutes a mixture or blend of dicarboxylic acid molecules of the above-noted formula, but the precise chemical formula of the dicarboxylic acid molecules included in the mixture/blend are non-uniform. Thus, in a typical blend/mixture, a percentage of the dicarboxylic acid molecules may be characterized by R₁═C9, a percentage of the molecules are characterized by R₁═C10, a percentage of the molecules are characterized by R₁═C11, etc. On a weighted basis, exemplary embodiments of the present disclosure include dicarboxylic acid molecules wherein the average R₁ hydrocarbon chain length is typically in the range of C12.

With reference to the sodium/potassium/monovalent cation constituents, exemplary blends/mixtures according to the present disclosure generally include molecules that include both N+ and K+ alkali metal constituents. Thus, M+ for purposes of a percentage of the molecules in the exemplary blend/mixture is sodium, while M+ for purposes of a second percentage of the molecules in the exemplary blend/mixture is potassium, and M+ for a third percentage of the molecules in the exemplary blend/mixture is sodium as to one position and potassium as to the second position. In an exemplary embodiment of the present disclosure, on a molar basis, sodium constitutes about 90 to 100% and potassium constitutes about 0 to 10%.

An advantageous technique for synthesizing the dicarboxylic acid materials, compositions and systems disclosed herein is provided in U.S. Pat. No. 7,407,535, previously incorporated herein by reference. Of note, the active dicarboxylic acid compositions disclosed herein are water soluble and are generally stored, distributed and utilized in an aqueous form.

The disclosed water soluble material, composition or system also includes a siloxane material, e.g., a polysiloxane constituent. Exemplary polysiloxane materials for use according to the present disclosure are commercially available, e.g., Tegosivin 746 (Evonik Industries, Hopewell, Va.), Siloxane PD (Prosoco, Inc., Lawrence, Kans.) or Silres BS SMK 2101 (Wacker Chemical Corporation, Adrian, Mich.). However, the present disclosure is not limited to such commercially available polysiloxane materials; rather, the disclosed water soluble material, composition or system may include various polysiloxane materials and polysiloxane-based systems.

Exemplary sealing/waterproofing solutions and systems of the present disclosure may farther include a thinning agent and/or a carrier that is effective to reduce the viscosity of the disclosed solution/system. For example, a thinning agent may be incorporated into the disclosed solution/system in an amount of about 5% to about 70% by weight. The thinning agent advantageously facilitates penetration of the disclosed water soluble corrosion-inhibiting solution/system into the concrete-containing structure, e.g., through pores, cracks and/or fissures formed or defined in the concrete-containing structure. Exemplary thinning agents include isopropyl alcohol or a similar solvent (or combinations thereof). Of note, the disclosed thinning agents may additionally function to reduce the potential for impurity(ies) to react with the disclosed solution/system, e.g., potential reactions with Ca⁺² ions in the concrete-containing structures, thereby enhancing the stability and/or overall effectiveness of the disclosed corrosion-inhibiting solution/system.

Concrete-containing materials and structures that may be treated with the disclosed solutions/systems vary widely, and include structures such as reinforced or un-reinforced concrete assemblies or elements, mortar, stucco, masonry, brick and the like. In exemplary embodiments of the present disclosure, the disclosed solution/system may be applied directly to the exterior surface of a reinforced and/or un-reinforced concrete structure and be permitted to penetrate to interior regions thereof, e.g., by capillary action.

Additional features, functionalities and beneficial results associated with the disclosed solution/system and treatment modalities associated therewith will be apparent from the detailed description which follows.

### BRIEF DESCRIPTION OF THE FIGURES

To assist those of ordinary skill in the art in making and using the subject matter of the present disclosure, reference is made to the accompanying figures, wherein:

FIG. 1 is a plot of water absorption for various substrates according to experimental studies associated with the present disclosure;

FIG. 2 is a plot of long-term absorption profiles for various substrates according to further experimental studies associated with the present disclosure; and

FIG. 3 is a further plot of absorption profiles for various substrates according to additional experimental studies associated with the present disclosure.

### DESCRIPTION OF EXEMPLARY EMBODIMENT(S)

The disclosed materials, compositions and systems advantageously deliver integral sealing/waterproofing that substantially eliminates the need for external membranes, coatings and sheeting treatments. As described herein, treatment of concrete-containing materials, systems and/or surfaces with the disclosed materials, compositions and systems achieves synergistic results as compared to the results achievable with either of the constituent compositions individually. Thus, the present disclosure provides advantage sealing/waterproofing compositions that include, in combination, a dicarboxylic acid and a polysiloxane, to achieve beneficial sealing/waterproofing results for concrete systems/surfaces.

Thus, as set forth above, the disclosed water soluble material, composition or system includes dicarboxylic acid molecules of the following formula:

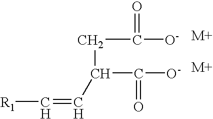

wherein R₁ is a branched hydrocarbon and M+ is Na+, K+ or other monovalent cation constituent. The disclosed water soluble material, composition or system also includes a siloxane material, e.g., a polysiloxane constituent. Exemplary polysiloxane materials for use according to the present disclosure include commercially available materials, e.g., Tegosivin 746 (Evonik Industries, Hopewell, Va.). However, the present disclosure is not limited to such commercially available polysiloxane materials; rather, the disclosed water soluble material, composition or system may include various polysiloxane materials and polysiloxane-based systems.

Generally, the disclosed dicarboxylic acid molecules of the above-noted formula constitute a mixture or blend and the precise chemical formula of the dicarboxylic acid molecules included in the mixture/blend are non-uniform. Thus, in a typical blend/mixture, a percentage of the dicarboxylic acid molecules may be characterized by R₁═C9, a percentage of the molecules are characterized by R₁═C10, a percentage of the molecules are characterized by R₁═C11, etc. As noted above, on a weighted basis, exemplary embodiments of the present disclosure include dicarboxylic acid molecules wherein the average R₁ hydrocarbon chain length is typically in the range of C12.

With reference to the sodium/potassium/monovalent cation constituents, exemplary blends/mixtures according to the present disclosure generally include molecules that include both N+ and K+ alkali metal constituents. Thus, M+ for purposes of a percentage of the molecules in the exemplary blend/mixture is sodium, while M+ for purposes of a second percentage of the molecules in the exemplary blend/mixture is potassium, and M+ for a third percentage of the molecules in the exemplary blend/mixture is sodium as to one position and potassium as to the second position. In an exemplary embodiment of the present disclosure, on a molar basis, sodium constitutes about 90 to 100% and potassium constitutes about 0 to 10%.

An advantageous technique for synthesizing the dicarboxyic acid materials, compositions and systems disclosed herein is provided in U.S. Pat. No. 7,407,535, previously incorporated herein by reference. Of note, the active dicarboxylic acid compositions disclosed herein are water soluble and are generally stored, distributed and utilized in an aqueous form.

The sealing/waterproofing material, composition or system of the present disclosure may be applied to a hardened concrete-containing structure or surface through various treatment techniques, e.g., by spraying, brushing or misting an effective amount of the disclosed material, composition or system onto one or more surfaces of the concrete-containing structure.

### Experimental Testing

Water permeability for surface applied and/or penetrating sealing/waterproofing materials can be assessed using a water absorption test. For example, the test method described in British Industrial Standard BSI 1881-122 uses a hardened concrete or mortar sample that is dried in an oven for an appropriate period (e.g., three days), cooled for an appropriate period (e.g., one day), and then immersed in a water bath for a predetermined period (e.g., thirty minutes). Measurement is then made of the water weight absorbed over the course of the noted immersion.

1. Preparation of Concrete Samples

For purposes of the water absorption testing herein, concrete samples were made according to mix designs set forth in TABLE 1 below. Concrete samples were cast into cylinders measuring 3 inches in diameter and 6 inches in height. Concrete samples were allowed to moist cure for 28 days under time water, and were then placed in air on a rack in conditions of 50% relative humidity (RH) at about 72° F. for an additional 7 days (or longer) to attain a surface dry state.

TABLE 1
Mix Designs of Concrete

| | Mix A (kg) | Mix B (kg) | Mix C (kg) |
|---|---|---|---|
| Type I Portland | 13.2 | 13.2 | 13.2 |
| Cement | | | |
| Fly Ash | 2.3 | 2.3 | 2.3 |
| Water | 6.75 | 5.98 | 5.21 |
| Concrete Sand | 26.7 | 26.7 | 26.7 |
| Coarse Stone (¾ inch) | 38.3 | 38.3 | 38.3 |
| Water/concrete ratio | 0.50 | 0.45 | 0.40 |

2. Application of Sealing/Waterproofing Compositions

Waterproofing materials were applied to concrete samples by immersion of the samples in the waterproofing material. The immersion mode of application assures even coverage, although it is contemplated that the disclosed sealing/waterproofing materials/compositions will generally be applied by spraying, rolling, brushing or the like. The amount of waterproofing material applied to the concrete sample was determined by differential measurement of mass increase of the concrete samples, i.e., by comparing the initial dry weight with the post-immersion waterproofed weight. The mass of waterproofing composition absorbed is then converted into a volume using the measured density of the waterproofing material. The surface area of the cylinder is calculated from caliper measured diameter and height. The amount of treatment applied is then expressed in a standard unit of coverage in the industry, i.e., square feet per gallon.

The dicarboxylic acid/polysiloxane material of the present disclosure was diluted to a concentration of 2% solids solution by mass. Water-based polysiloxane penetrating water repellants were purchased commercially and were measured to contain active material concentrations of 1.5% to 5.5% by weight.

3. Overview of Results

Application of the dicarboxylic acid hydrophobic waterproofing solution described in commonly assigned U.S. Pat. No. 7,407,535 showed inferior performance as compared to commercially available polysiloxane materials. However, the combination of the present disclosure, e.g., combinations that included a dominant amount of the dicarboxylic acid hydrophobic waterproofing solution described in commonly assigned U.S. Pat. No. 7,407,535 and a small addition of the commercially available polysiloxane material resulted in performance nearly equal to a full dosage of the commercially available polysiloxane material by itself. The ability to achieve comparable results despite a significant reduction in the amount of polysiloxane employed translates to a substantial cost advantage and reduction of Volatile Organic Compounds (VOCs) as compared to use of the commercially available polysiloxane materials alone.

### EXAMPLE 1

Concrete cylinders measuring 3 inches in diameter and 6 inches in height were cast from Mix Design B set forth in TABLE 1 above. As noted above, after 28 days of wet cure, the cylinders were allowed to dry on a rack for a week at 50% RH and 72° F.

One concrete cylinder was left nascent, i.e., untreated, to serve as a control. Other concrete cylinders were soaked in penetrating sealants to the weight corresponding to a desired coverage target expressed in square feet of coverage per gallon of penetrating sealant. The penetrating sealant candidates and soak weights are set forth in TABLE 2 below. All active ingredient percentages are on a solids basis.

TABLE 2
Penetrating Sealant Compositions

| | | | Dicarboxylic |
|---|---|---|---|
| | | Commercially | Acid |
| | Dicarboxylic | Available | and Polysiloxane |
| | Acid | Polysiloxane** | Combination |
| | Composition* | Waterproofer | at 9:1 ratio |
| Water | 98% | 98% | 98% |
| Dicarboxylic Acid | 2% | 0% | 1.8% |
| Composition* | | | |
| Polysiloxane** | 0% | 2% | 0.2% |
| Application Rate | 6.15 g | 10.5 g | 6.15 g |
| per Cylinder | | | |
| Coverage Rate | 300 sq.ft./gal | 175 sq.ft./gal. | 300 sq.ft./gal. |

*Dicarboxylic acid material as described in U.S. Pat. No. 7,407,535.
**Purchased commercially - Siloxane PD, Prosoco, Inc., Lawrence, KS

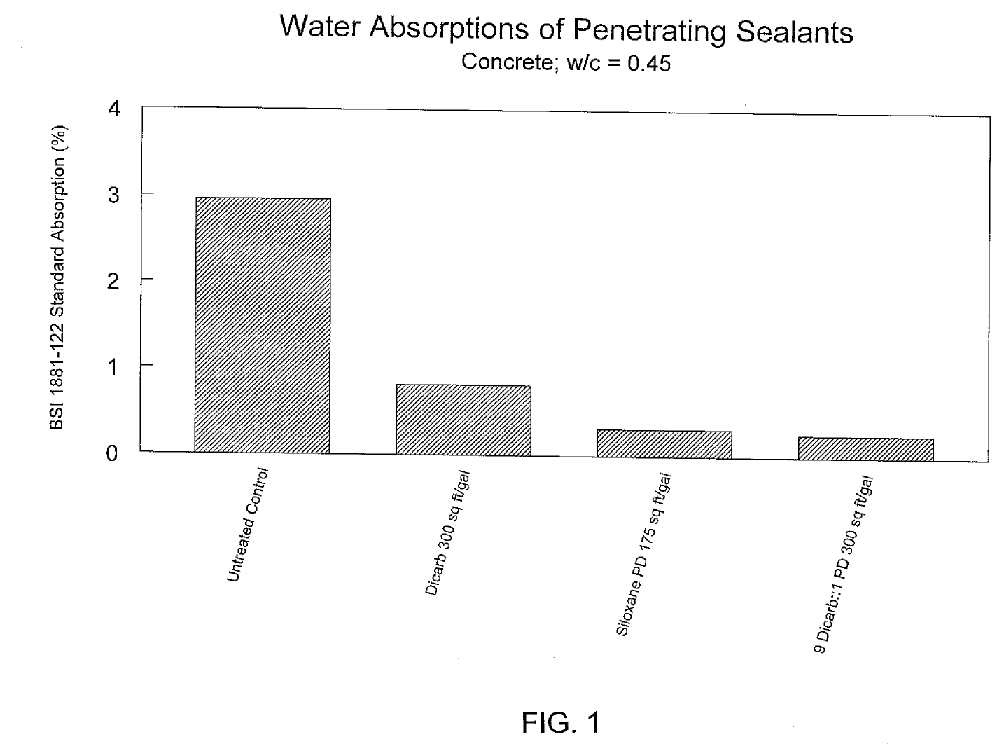

As shown in FIG. 1, testing demonstrated that the untreated control cylinder absorbed water to about 3% of its weight in 30 minutes. A concrete cylinder treated with the dicarboxylic acid composition of U.S. Pat. No. 7,407,535 (when used alone) absorbed 0.8% water at a coverage of 300 square feet per gallon. A concrete cylinder treated with a commercially available polysiloxane material Siloxane PD (Prosoco, Inc., Lawrence, Kans.) absorbed 0.3% water at a coverage of 175 square feet per gallon. Unexpectedly, a combination of the dicarboxylic acid composition of U.S. Pat. No. 7,407,535 at 9 parts and 1 part of commercial polysiloxane showed an absorption of only 0.25% water at a coverage of 300 square feet per gallon. This reduced water absorption performance reflects an unexpected synergistic effect with the combination as compared to treatment with either of the two materials alone, and such superior performance was achieved at a lower application rate as compared to the test regimen for the commercially available polysiloxane material alone.

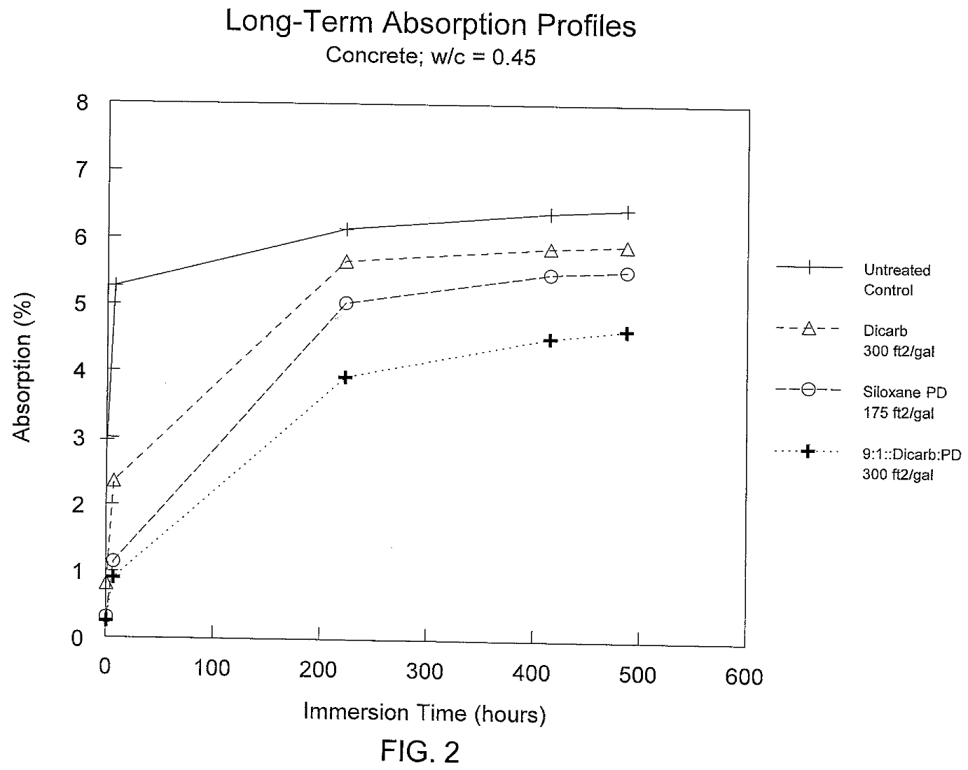

Further absorption measurements were made at longer immersion times. As shown in FIG. 2, the synergistic benefit of the combination (i.e., carboxylic acid/polysiloxane compositions) increases at longer immersion times.

### EXAMPLE 2

To confirm that the synergistic and beneficial effect noted in Example 1 is not being influenced and/or caused by an unidentified ingredient in the commercially available polysiloxane material used for the tests set forth in Example 1, a raw material polysiloxane [Tegosivin 746] was obtained from Evonik Industries (Hopewell, Va.).

TABLE 3 shows the combinations of dicarboxylic acid and polysiloxanes tested in this confirmatory experiment. All active ingredient percentages are on a solids basis.

TABLE 3
Penetrating Sealant Compositions

| | | | Dicarboxylic | |
|---|---|---|---|---|
| | | Commercially | Acid + | |
| | | Available | Commercially | Dicarboxylic |
| | Dicarboxylic Acid | Polysiloxane** | Available | Acid + |
| | Composition* | Waterproofer | Polysiloxane | Tegosivin 746 |
| Water | 98% | 98% | 98% | 98% |
| Dicarboxylic | 2% | 0% | 1.8% | 1.8% |
| Acid | | | | |
| Composition | | | | |
| Polysiloxane** | 0% | 2% | 0.2% | 0% |
| Tegosivin 746 | 0% | 0% | 0% | 0.2% |
| Application | 6.15 g | 10.5 g | 6.15 g | 6.15 g |
| Rate per | | | | |
| Cylinder | | | | |
| Coverage Rate | 300 sq.ft/gal. | 175 sq.ft./gal. | 300 sq.ft/gal. | 300 sq.ft/gal. |

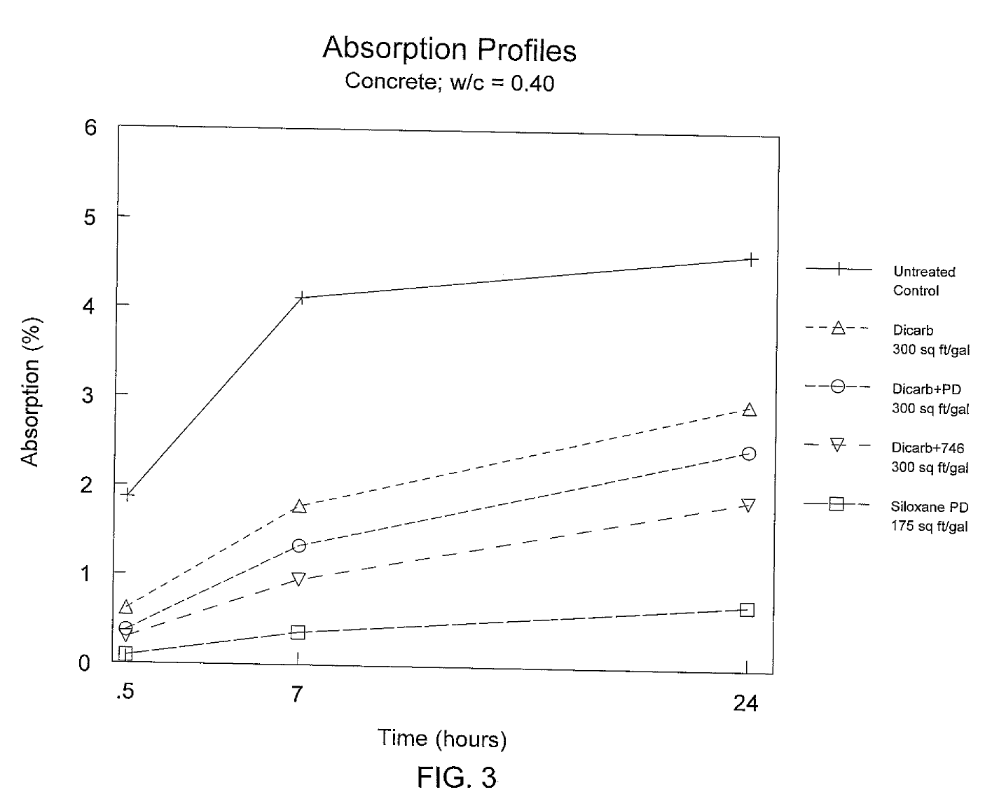

FIG. 3 shows the water absorption profiles of the dicarboxylic acid composition alone, the combination of the dicarboxylic acid composition with 10% substitution of raw polysiloxane [Tegosivin 746], dicarboxylic acid hydrophobic with 10% commercial polysiloxane penetrating sealant Siloxane PD (Prosoco, Inc., Lawrence, Kans.), and the 100% commercial polysiloxane penetrating sealant (at a higher application dosage, per manufacturer's recommendation). The synergistic benefits associated with the disclosed combination of dicarboxylic acid/polysiloxane is readily apparent from the results reflected in FIG. 3, with the absorption values of the disclosed combination approaching the commercial polysiloxane penetrating sealant alone (despite a 90% reduction in polysiloxane level).

Thus, the present disclosure provides advantageous combinations of dicarboxylic acid and polysiloxane constituents that provide synergistically beneficial sealing/waterproofing performance when applied to concrete-containing materials/surfaces. In exemplary embodiments of the present disclosure, the constituents are combined at a ratio of about 9:1 dicarboxylic acid constituent to polysiloxane constituent. However, alternative ratios may be employed without departing from the spirit or scope of the present disclosure. Thus, for example, advantageous/synergistic sealing/waterproofing results may be achieved with dicarboxylic acid to polysiloxane ratios ranging from about 20:1 to about 1:1. In exemplary implementations of the present disclosure, the ration of dicarboxylic acid to polysiloxane may be on the order of about 2:1. Additional constituents may also be added to the disclosed aqueous system, e.g., thinning agents, defoaming agents and the like, without departing from the present disclosure.

In use, the disclosed combination may be applied and reapplied to a concrete-containing structure/surface to achieve desired sealing/waterproofing results. Exemplary treatments may be in the range of 300 sq. ft/gallon, although various coverage rates may be employed to achieve desired results, e.g., depending on environmental conditions, concrete properties, and the like. Multiple coats of the disclosed combination may also be employed.

While the present invention has been described with respect to the exemplary embodiments thereof, it will be recognized by those of ordinary skill in the art that many modifications, enhancements, variations and/or changes can be achieved without departing from the spirit and scope of the invention. Therefore, it is manifestly intended that the invention be limited only by the scope of the claims and equivalents thereof.

1. A composition for use in treating a concrete-containing structure or surface, comprising:
(a) a first constituent of the formula: 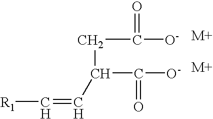
wherein R₁ is a branched hydrocarbon and M+ is a metal; and
(b) a second constituent comprising polysiloxane.

2. A composition according to claim 1, wherein the first and second constituents are combined in an aqueous solution.

3. A composition according to claim 1, wherein R₁ is a C₉ to C₁₆ branched hydrocarbon.

4. A composition according to claim 1, wherein the first constituent comprises a blend or mixture of molecules having differing R₁ structures.

5. A composition according to claim 4, wherein the blend or mixture has a weighted average of about C₁₂.

6. A composition according to claim 1, wherein M+ is Na+, K+ or a combination thereof.

7. A composition according to claim 6, wherein M+ includes Na+ at a level of about 90 to 100 weight percent and K+ at a level of about 0 to 10 weight percent.

8. A composition according to claim 1, wherein the ratio of the first constituent to the second constituent is about 20:1 to about 1:1.

9. A method for treating a concrete-containing material, comprising:
(a) providing a composition including (i) a first constituent having a formula: 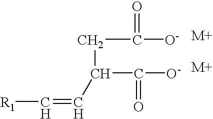
wherein R₁ is a branched hydrocarbon and M+ is a metal; and (ii) a second constituent comprising a polysiloxane.
(b) applying the composition to a concrete-containing structure or surface.

10. A method according to claim 9, wherein the composition is applied to the concrete-containing structure or surface in an amount sufficient to impart waterproof properties to the concrete-containing structure or surface.

11. A method according to claim 9, wherein the composition is applied to a concrete-containing structure or surface that includes at least one constituent selected from the group consisting of concrete, mortar, stucco, masonry, brick, and steel.

12. A method according to claim 9, wherein the composition is applied to the concrete-containing structure by an application mechanism selected from the group consisting of spray application, brush application, mist application, and combinations thereof.

13. A method according to claim 9, wherein the first and second constituents are combined in an aqueous solution.

14. A method according to claim 9, wherein R₁ is a C₉ to C₁₆ branched hydrocarbon.

15. A method according to claim 9, wherein the first constituent comprises a blend or mixture of molecules having differing R₁ structures.

16. A method according to claim 15, wherein the blend or mixture has a weighted average of about C₁₂.

17. A method according to claim 9, wherein M+ is Na+, K+ or a combination thereof.

18. A method according to claim 17, wherein M+ includes Na+ at a level of about 90 to 100 weight percent and K+ at a level of about 0 to 10 weight percent.

19. A method according to claim 9, wherein the ratio of the first constituent to the second constituent is about 20:1 to about 1:1.

20. A method according to claim 9, wherein application of the composition to the concrete-containing structure or surface imparts waterproof properties to said concrete-containing structure or surface.
